(19) United States
(12) Patent Application Publication
(10) Pub. No.: US 2009/0193989 A1
(43) Pub. Date: Aug. 6, 2009

(54) WEB OFFSET PRESS AND OPERATION METHOD FOR THE SAME

(75) Inventor: Shinichiro Senoo, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/306,276

(22) PCT Filed: Jul. 17, 2007
(86) PCT No.: PCT/JP07/64115

§ 371 Date: Dec. 23, 2008

(30) Foreign Application Priority Data
Jul. 18, 2006 (JP) 2006-196033

(51) Int. Cl. B41F 5/04

(52) U.S. Cl. 101/219

(57) ABSTRACT

An object of the present invention is to provide a web offset press that is capable of reducing costs and reliably preventing wrinkles that occur in a web during low-speed operation. A web offset press includes a printing section that prints on a web that is transported; an in-feed drag that is provided upstream of the printing section and that adjusts a tension of the web and transports it downstream; a cooling drag that is provided downstream of the printing section and that transports the web at a transport speed higher than that of the in-feed drag; and a tension control unit that controls a tension of the web. The tension control unit has a tension-release operating mode (TM) where a transport-speed difference between the cooling drag and the in-feed drag is smaller than a transport-speed difference between the cooling drag and the in-feed drag during printing.

### TECHNICAL FIELD

The present invention relates to a web offset press and a method for operating the same.

### BACKGROUND ART

A web offset press, such as a commercial offset press, is a machine in which a web continuously let out from a paper feeder is adjusted in tension at an in-feed unit, and then passes in turn through a printing section, a drying unit, a cooling unit, a web-path unit, and a folding device to be processed into a folded sheet subjected to desired printing during that time.

In this web offset press, drags, i.e., a cooling drag, a web-path drag, and a folding drag, which apply a transport speed that is higher than or lower than an upstream web-transport speed are provided in the cooling unit, the web-path unit, and the folding device, respectively.

The cooling drag and the web-path drag apply respective transport speeds at a constant ratio (drag rate) relative to the upstream drag and perform draw control in which an appropriate tension is applied to the web to stabilize the tension of the web between the printing section and the web-path unit.

The folding drag draws the web at a predetermined speed higher than that at the upstream side and applies the tension required for a folding operation to the web.

In the web offset press, various preparatory operations are performed other than during printing, and most of these preparatory operations are performed in a state in which cylinder is disengaged while the web is transported at low speed.

At this time, with the conventional web offset press, the cooling drag and the web-path drag are operated with the same setting as is used during printing.

Because they are operated with the cylinder being disengaged, the web is not engaged with or supported by any blanket cylinders, rollers, or the like from the in-feed unit to the cooling unit. In this way, because the length over which the web becomes free, i.e., the length over which the web is not restricted, becomes significantly larger than during printing, wrinkles (longitudinal wrinkles) may occur in the web at the upstream portion in the traveling direction of the web in the cooling unit, that is, a portion where support (restriction) of the web ends.

This type of “wrinkle” tends to occur when the web is thin paper. When wrinkles occur in the web in this way, paper breakage tends to occur due to the wrinkles, thus causing a significant reduction of productivity of the press.

One way of reducing the occurrence of wrinkles is not to perform tension control in the in-feed unit during low-speed operation; however, this is inadequate.

Another way of preventing the occurrence of wrinkles by controlling tension by changing the cooling drag to perform draw control has been proposed as described in Patent Document 1 and Patent Document 2.

With the approach disclosed in Patent Document 1, tension control is performed only during low-speed operation, and with the approach disclosed in Patent Document 2, tension control is performed at all times, i.e., during printing and low-speed operation.

Patent Document 1: Japanese Unexamined Patent Application, Publication No. HEI 6-122188

Patent Document 2: Japanese Unexamined Patent Application, Publication No. 2000-127352

### DISCLOSURE OF INVENTION

However, in order to control the tension, because it is necessary to add expensive devices and control means, there is a problem in that manufacturing costs increase.

In addition, the tension needs to be measured; however, with the conventional web offset press, a tension detector is generally placed between the cooling unit and the web-path unit. When using it, because the tension between the cooling unit and the web-path unit is controlled, it is not possible to prevent wrinkles that occur at an inlet of the cooling unit. Accordingly, the tension detector should be disposed just before the cooling unit, but this is difficult to realize in view of staining due to contact with the roller in which the tension detector is placed, costs, and countermeasures against heating during operation.

Furthermore, when the tension is small during, for example, low-speed operation, movement of the web is unstable; therefore, it is impossible to maintain the detection accuracy of the tension detector. Accordingly, there is a problem in that stable tension control cannot be performed. When the movement of the web becomes considerably unstable, the tension detector may be damaged, possibly resulting in the inability to perform control.

The present invention has been conceived in light of the problems described above, and an object thereof is to provide a web offset press that is less expensive and is capable of steadily preventing wrinkles that occur in a web during low-speed operation, and to provide a method for operating the same.

In order to solve the above problems, the present invention employs the following solutions.

Specifically, a first aspect of the present invention is a web offset press including a printing section that prints on a web that is transported; an upstream drag that is provided upstream of the printing section and that adjusts a tension of the web and transports the web downstream; a downstream drag that is provided downstream of the printing section and that transports the web at a transport speed higher than that of the upstream drag; and a tension control unit that controls the tension of the web, wherein the tension control unit has a tension-release operating mode in which a transport-speed difference between the downstream drag and the upstream drag is smaller than a transport-speed difference between the downstream drag and the upstream drag during printing.

In this way, because the tension-release operating mode in which the transport speed difference between the downstream drag and the upstream drag during printing is made small is provided, when the wrinkles tend to occur during low-speed operation, the transport speed difference (draw value) between the downstream drag and the upstream drag is made small using the tension-release operating mode.

When the transport speed difference (draw value) between the downstream drag and the upstream drag is made small, the tension applied on the web passing through the printing section becomes small. Accordingly, wrinkles can be prevented from occurring at a downstream drag portion.

In addition, in the tension-release operating mode, because draw control is simply performed by changing to a smaller setting of the draw value of the downstream drag, which transports the web at a higher speed than the upstream drag, stable operation can be realized, and a device, a sequence or a tension detector for control need not be added, thus preventing an increase in manufacturing costs.

The upstream drag used is, for example, an in-feed drag, and the downstream drag is, for example, a cooling drag or a web-path drag.

A plurality of draw values may be provided in the tension-release operating mode and selected according to the conditions. In addition, the draw value may continuously vary.

In addition, in the first aspect, the transport-speed difference in the tension-release operating mode is preferably set according to paper type.

By doing so, it is possible to select between implementing the tension-release operating mode to enable changing to a smaller draw value only when using thin paper in which wrinkles tend to occur, or alternatively, not implementing the tension-release operating mode when using thick paper having high stiffness.

In addition, a second aspect of the present invention is an operation method for a web offset press including a printing section that prints on a web that is transported; an upstream drag that is provided upstream of the printing section and that adjusts a tension of the web and transports the web downstream; a downstream drag that is provided downstream of the printing section and that transports the web at a transport speed higher than that of the upstream drag; and a tension control unit that controls the tension of the web, wherein, when the transport speed of the web is lower than that during printing, the tension control unit performs a tension-release operation in which a transport speed difference between the downstream drag and the upstream drag is made smaller than a transport-speed difference between the downstream drag and the upstream drag during printing.

In this way, when the transport speed of the web is lower than during printing, because the tension control unit performs the tension-release operation in which the transport speed difference between the downstream drag and the upstream drag is made smaller than the transport speed difference between the downstream drag and the upstream drag during printing, it is possible to reduce the tension applied to the web passing through the printing section. By doing so, wrinkles can be prevented from occurring at the downstream drag portion.

In addition, in the tension-release operation, because conventional draw control is simply performed by changing to a smaller setting of the draw value of the downstream drag, which transports the web at a higher speed than the upstream drag, stable operation is possible for the web offset press operated using this method, and a device, a sequence or a tension detector for control need not be added, thus preventing an increase in manufacturing costs.

The upstream drag used is, for example, an in-feed drag, and the downstream drag is, for example, a cooling drag or a web-path drag.

A plurality of draw values may be provided in the tension-release operating mode and selected according to the conditions. In addition, the draw value may continuously vary.

In addition, in the second aspect, the transport-speed difference during the tension-release operation is preferably set according to paper type.

By doing so, it is possible to select between implementing the tension-release operation to enable changing to a smaller draw value only when using thin paper in which wrinkles tend to occur, or alternatively, not implementing the tension-release operation when using thick paper having high stiffness.

With the web offset press according to the first aspect of the present invention, because it is provided with the tension-release operating mode in which the transport speed difference between the downstream drag and the upstream drag during printing is made small, wrinkles can be prevented from occurring at the downstream drag portion.

In addition, in the tension-release operating mode, because the conventional draw control is simply performed by changing to a smaller setting of the draw value of the downstream drag, which transports the web at a higher speed than the upstream drag, stable operation can be realized, and a device, a sequence or a tension detector for control need not be added, thus preventing an increase in manufacturing costs.

With the operation method for the web offset press according to the second aspect of the present invention, when the transport speed of the web is lower than during printing, because the tension control unit performs the tension-release operation in which the transport speed difference between the downstream drag and the upstream drag is made smaller than the transport speed difference between the downstream drag and the upstream drag during printing, wrinkles can be prevented from occurring at the downstream drag portion.

In addition, in the tension-release operation, because the conventional draw control is simply performed by changing to a smaller setting of the draw value of the downstream drag, which transports the web at a higher speed than the upstream drag, stable operation is possible for the web offset press operated using this method, and a device, a sequence or a tension detector for control need not be added, thus preventing an increase in manufacturing costs.

### BRIEF DESCRIPTION OF DRAWINGS

FIG. 1 is a front view schematically showing the overall configuration of a web offset press according to an embodiment of the present invention.

FIG. 2 is a block diagram showing a tension-release control unit according to an embodiment of the present invention.

FIG. 3 is a timing chart showing an example of a method for operating a web offset press according to an embodiment of the present invention.

FIG. 4 is a flowchart of a tension-release operating mode according to an embodiment of the present invention.

### EXPLANATION OF REFERENCE SIGNS

1: web offset press
7: printing section
17: web
21: in-feed drag
39: cooling drag
43: web-path drag
61: tension control unit
63: tension-release control unit
TM: tension-release operating mode

### BEST MODE FOR CARRYING OUT THE INVENTION

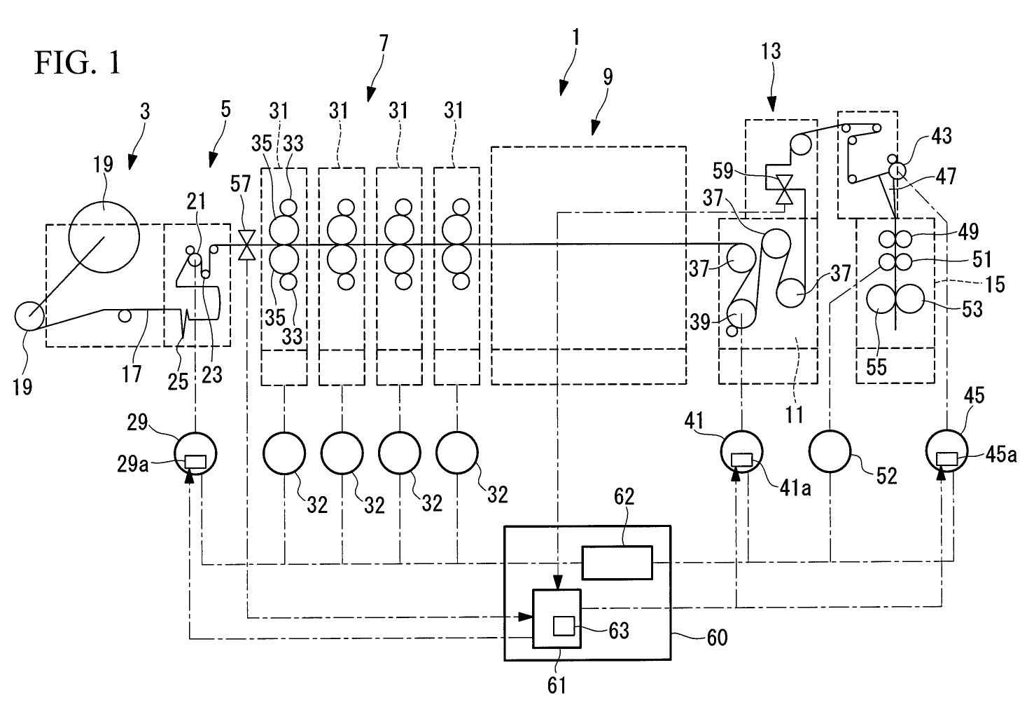

An embodiment of the present invention will be described below with reference to FIGS. 1 to 4.

In this embodiment, the present invention is applied to an opposing-blanket-type web offset press 1 that performs multiple-color printing on both sides of a web.

FIG. 1 is a schematic view showing the overall configuration of the web offset press 1.

The web offset press 1 has a paper feeder 3, an in-feed unit 5, a printing section 7, a drying unit 9, a cooling unit 11, a web-path unit 13, and a folding device 15.

The paper feeder 3 supplies a web 17 and is configured to hold two paper rolls 19 on which the web 17 is wound into a roll.

When paper is supplied from one of the paper roll 19, the other paper roll 19 is loaded to prepare for paper splicing. When the remaining amount of the web 17 on the one paper roll 19 becomes small, it is spliced with the web 17 on the other paper roll 19. Likewise, while the web 17 is supplied from the other paper roll 19, the one paper roll 19 is loaded to prepare for paper splicing.

In this way, the web 17 is continuously let out from the paper feeder 3 toward the downstream side.

In addition, the shaft of each paper roll 19 has a paper feed brake for regulating paper feeding.

The in-feed unit 5 has an in-feed drag (upstream drag) 21, dancer rollers 23, and a tension-variation absorbing damper 25.

The in-feed drag 21 is a portion that continuously pulls out the web 17 from the paper rolls 19 and that is formed to be driven by an in-feed-unit shaftless motor 29 having a continuously variable transmission 29a. Here, a configuration in which the in-feed drag 21 holds the web 17 with a roller is employed.

The dancer rollers 23 are rollers disposed substantially orthogonal to the transport direction of the web 17 and disposed parallel to the web 17. The dancer rollers 23 are elastically supported by air cylinders (not shown) in the vertical direction (i.e., in the direction away from the traveling surface of the web 17).

When the tension of the web 17 is small, the dancer rollers 23 are lowered by the air cylinder to increase the tension of the web 17, and when tension of the web 17 is large, the dancer rollers 23 are raised against the air cylinder to decrease the tension of the web 17.

A tension-variation absorbing damper 25 is a damper that absorbs variations in the tension of the web 17.

In the printing section 7, printing units 31, the number of which corresponds to the number of printing colors, are provided side-by side in a direction in which the web 17 is transported.

In this embodiment, four printing units 31 are provided, which are used for printing cyan, yellow, magenta and black, respectively. Color printing is carried out by mixing these colors.

The printing units 31 are each provided with a pair of plate cylinders 33 and a pair of blanket cylinders 35 to allow double-sided printing. The pair of blanket cylinders 35 is disposed facing each other with the web 17 interposed therebetween, functioning to press against each other.

Dampening devices and ink devices (not shown) are provided around the circumferential surfaces of the respective plate cylinders 33. The dampening devices supply dampening water to printing plates attached around the plate cylinders 33, and the ink devices supply ink to the printing plates.

The printing units 31 are configured to be independently driven by printing-section shaftless motors 32, respectively.

In addition, though not shown in the drawing, an automatic-register sensor is provided at an outlet of the fourth printing unit 31 or at the web-path unit 13.

The automatic-register sensor detects the color-shift amount of each color to adjust the register by driving an orientation-register motor (not shown) provided for the plate cylinders 33, according to the detected color-shift amount of each color, thus making the color-shift amount of each color approach zero.

The drying unit 9 has a function for heating and drying the web 17, on which printing has been carried out by the printing section 7 on both sides thereof.

The cooling unit 11 is provided with a plurality of cooling drums 37. The web 17 heated at the drying unit 9 is made to pass through in a manner as to contact the circumferential surface of each cooling drum 37, thus cooling the web 17.

In addition, the second cooling drum constitutes a cooling drag (downstream drag) 39. Similar to the above-described in-feed drag 21, the cooling drag 39 is constituted to be driven by a cooling-unit shaftless motor 41 having a continuously variable transmission 41a. In addition, the cooling drag 39 also has a roller for holding the web 17.

The web-path unit 13 is constituted of a plurality of guide rollers and has a web-path drag 43 downstream thereof.

Similar to the above-described in-feed drag 21, the web-path drag 43 is configured to be driven by a web-path unit shaftless motor 45 having a continuously variable transmission 45a.

The web-path drag 43 has a function for adjusting the tension of the web 17 to supply it to the folding device 15, and also has a roller for holding the web 17.

Here, the web-path unit 13 may have a cutting function for longitudinally cutting (slitting) the web 17 when necessary.

A cut-off sensor (not shown) is provided directly before the inlet of the web-path unit 13.

The cut-off sensor detects the phase of the entire image to perform cut-off (cutting position) adjustment by driving a full-width compensation motor (not shown) in the web-path unit 13 according to the detected phase, thus making it possible for the phase of the image to be aligned with that of the folding device so as to cut the web 17 at an appropriate position.

The web 17 is folded in half in the folding unit 15 by way of a triangular plate 47, then passes in turn through lead-in rollers 49 and folding drags (nipping rollers) 51, is cut and folded at a predetermined position into a desired form of folded sheet by a cutting cylinder 53 and a folding cylinder 55, and is then transported outside. Here, the folding drags 51 also have a folding-drag-unit shaftless motor 52.

In addition, as a way of detecting the tension state of the web 17, an in-feed tension pick 57 disposed directly before the printing section and a web-path tension pick 59 disposed at an inlet of the web-path unit 13 are provided.

The web offset press 1 has a control unit 60 including a tension control unit 61 and a virtual-shaft control unit 62. Here, the virtual-shaft control unit 62 controls phases of the in-feed-unit shaftless motor 29, the printing-section shaftless motor 32, the cooling-unit shaftless motor 41, the web-path unit shaftless motor 45, and the folding-drag-unit shaftless motor 52 in synchronization with a virtual shaft, thus realizing printing control similar to a conventional drive control using a real shaft.

The tension control unit 61 has a function for controlling the operation of the in-feed drag 21, the cooling drag 39, and the web-path drag 43, and controlling the tension of the transported web 17. In addition, the folding drags 51 are controlled to drag at a constant drag rate with respect to the control of these drags.

By referring to a detection result from the in-feed tension pick 57, the tension control unit 61 controls the tension so that the result becomes a target tension. Specifically, in the in-feed unit 5, by operating the in-feed-unit shaftless motor 29, having the continuously variable transmission, such that the dancer rollers 23 are positioned at a substantially constant position and by adjusting a circumferential speed of the in-feed drag 21 (transport speed of the web 17), the tension is controlled so that the tension of the web 17 becomes a target tension.

In addition, an operator manually adjusts the circumferential speed of the cooling drag 39 and the web-path drag 43 to a desired tension according to a reading from the web-path tension pick 59, thus realizing a draw control system in which tension is stabilized at a constant drag rate.

In addition, draw control is performed in the cooling unit 11 and the web-path unit 13 by operating the cooling-unit shaftless motor 41 and the web-path unit shaftless motor 45 to be driven with a circumferential speed (transport speed of the web 17) of the cooling drag 39 and a circumferential speed of the web-path drag 43 (transport speed of the web 17) having a constant circumferential speed ratio (draw value) relative to a circumferential speed of an upstream drag. Here, the draw value is a value indicating whether the circumferential speed of the drag rollers should be higher or lower with reference to the speed of the printing section 7 or the folding device.

The draw value of the cooling drag 39 is set to, for example, 0.06%. With this configuration, the circumferential speed of the cooling drag 39 is controlled so that it is 100.06% of the transport speed of the printing section 7.

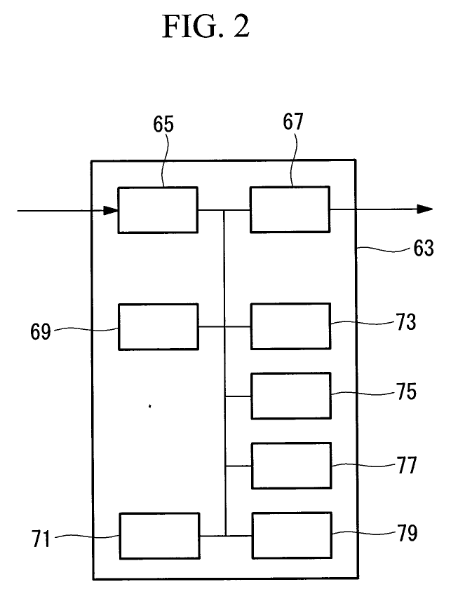

The tension control unit 61 has a tension-release control unit 63 that runs in a tension-release operating mode TM. FIG. 2 is a block diagram showing, in outline, the configuration of the tension-release control unit 63.

The tension-release control unit 63 has an input unit 65, an output unit 67, a decision unit 69, a normal-draw-value storage unit 71, a first released-draw-value storage unit 73, a second released-draw-value storage unit 75, a third released-draw-value storage unit 77, and a fourth released-draw-value storage unit 79.

The input unit 65 receives, for example, a basis weight, a paper width, and a transport speed of the web 17 from a production control device.

The input unit 65 receives information about the basis weight, etc. of the web 17 from the production control device to determine the paper type, mainly the paper thickness, at the decision unit 69. Any type of information may be received, so long as it correlates with the paper thickness, such as a tension preset value from the production control device, or a tension set value or a tension value of the in-feed unit 5 during printing. For example, when a value is not directly obtained, a backup system may be used to obtain it by conversion using a correlation database, a correlation function, or the like.

The normal-draw-value storage unit 71 stores a draw value during printing, for example, 0.06%,; the first released-draw-value storage unit 73 stores a first released-draw value, for example, 0%; the second released-draw-value storage unit 75 stores a second released-draw value, for example, 0.01%; the third released-draw-value storage unit 77 stores a third released-draw value, for example, 0.02%; and the fourth released-draw-value storage unit 79 stores a fourth released-draw value, for example, 0.04%.

Among each of the draw values stored in the normal-draw-value storage unit 71, the first released-draw-value storage unit 73, the second released-draw-value storage unit 75, the third released-draw-value storage unit 77, and the fourth released-draw-value storage unit 79, the decision unit 69 determines an optimal draw value based on the information input to the input unit 65 and sends the selected draw value to the output unit 67.

The output unit 67 operates the cooling-unit shaftless motor 41 having the continuously variable transmission based on the selected draw value sent from the decision unit 69.

In this embodiment, the decision unit 69 selects one of a plurality of draw values; however, it is also possible to provide, for example, a draw value function that continuously varies according to the paper type conditions, and the decision unit 69 calculates a draw value according to the paper type, and the draw value of the calculation result is supplied to the output unit 67.

The operation of the above-described web offset press 1 according to this embodiment will be described.

First, the printing operation will be described.

A rotational driving force from the in-feed-unit shaftless motor 29 is transmitted to the in-feed drag 21 of the in-feed unit 5. The in-feed drag 21 is rotationally driven at a predetermined rotational speed on the basis of a command from the tension control unit 61.

The web 17 let out from the paper feeder 3 is pulled out by the in-feed drag 21, is adjusted to a constant target tension by the dancer rollers 23, and is then supplied to the printing section 7.

In the printing section 7, by supplying dampening water and ink to each printing unit 31, images formed on the printing plates attached around the plate cylinders 33 are transferred onto the blanket cylinders 35.

The transferred images are transferred onto both sides of the web 17 that passes through between the blanket cylinders 35 and 35, and printing is performed.

By passing through four printing units 31, black, cyan, magenta, and yellow are printed on the web 17, thus performing color printing.

The web 17 printed in the printing section 7 is heated in the drying unit 9 to dry the ink.

Next, the web 17 passes through so as to contact a circumferential surface of each cooling drum 37 in the cooling unit 11, and is cooled by each cooling drum 37.

At this time, a rotational driving force from the cooling-unit shaftless motor 41 is transferred to the cooling drag 39. The cooling drag 39 is rotationally driven, on the basis of a command from the tension control unit 61, at a predetermined drag rate relative to the printing speed (circumferential speed of the in-feed drag 21), for example, a circumferential speed obtained by adding 0.06%. By doing so, because the web 17 transported in the printing section 7 is pulled and tension is applied thereto, the tension of the web 17 in the printing section 7 becomes stable, thus performing superior printing.

The web 17 cooled in the cooling unit 11 is rotationally driven, by the web-path drag 43 of the web-path unit 13, at a circumferential speed obtained by adding or subtracting a predetermined drag rate. By doing so, the web 17 is supplied to the folding device 15 with its tension being adjusted.

The web 17, which is folded in the longitudinal direction by the triangular plate 31 and enters the folding device 15, is guided by the lead-in rollers 49 and is then transported downstream by the folding drags 51.

The web 17 is cut (cross cut) and folded at a predetermined position into a desired form of folded sheet by the cutting cylinder 53 and the folding cylinder 55, and is then carried outside.

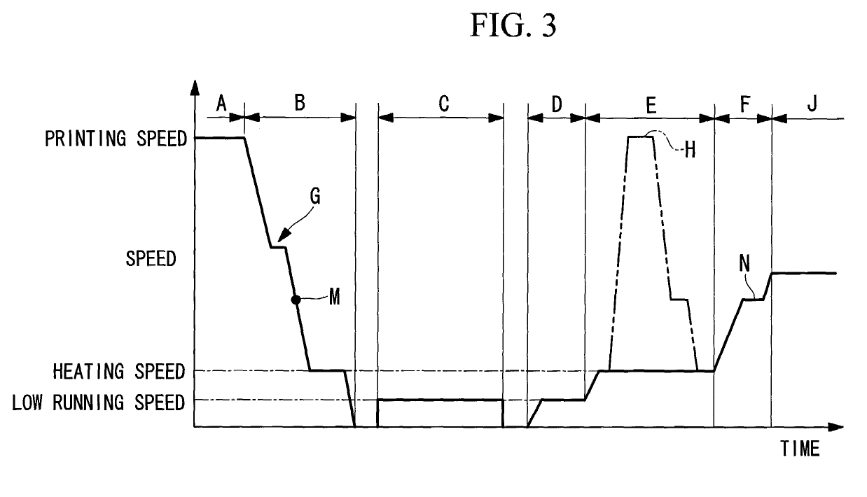

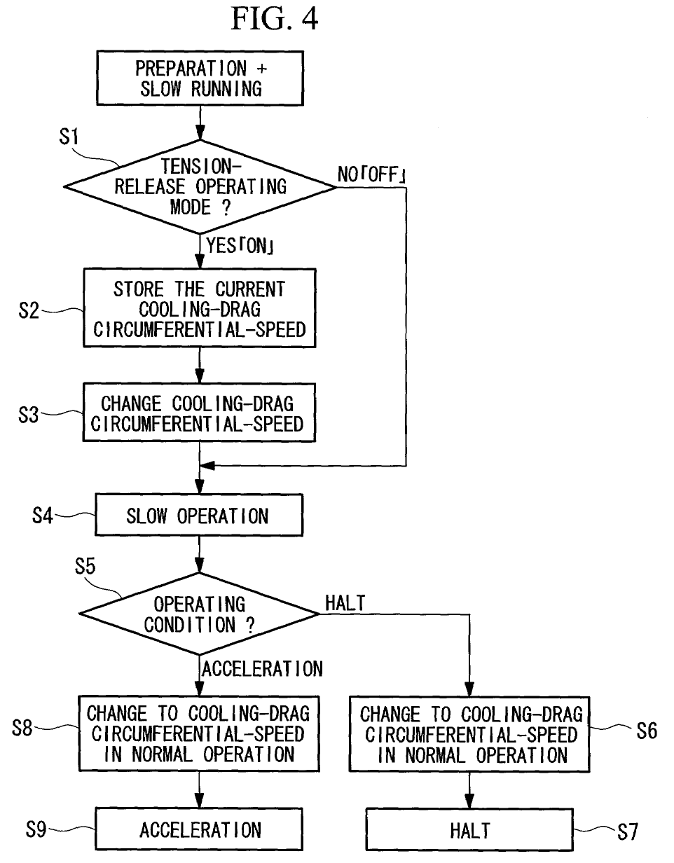

Next, the operation until commencing the subsequent printing, after completion of printing will be described with reference to FIGS. 3 and 4.

FIG. 3 is a timing chart showing the temporal change of the rotational speed of the printing unit 31 and the running speed of the web 17 when performing blanket cleaning during the time between completion of printing and starting the printing. FIG. 4 is a flowchart showing the operation using the tension-release operating mode.

In addition, in FIG. 3, the solid line indicates the running speed of the web, and the two-dot chain line indicates the rotational speed of the printing unit. Parts where the solid line and the two-dot chain line overlap are indicated only by the solid line.

After completion of a printing process A, a speed-reduction process B is performed in which the transport speed of the web 17 is reduced from a predetermined production speed to a halted state.

At this time, a constant-speed period of relatively short duration is provided for the running speed (i.e., rotational speed of the printing unit 31) of the web 17 whose speed has been reduced, and during this period, an ink-amount reduction process G is performed where an amount of ink in an ink-roller group is reduced.

Furthermore, cylinder disengagement is performed during the speed reduction, where the web 17 and the blanket cylinders 35 of each printing unit 31 in the printing section 7 are disengaged.

In the speed-reduction process G, the tension applied to the web 17 that passes through the printing section 7 may be reduced using the tension-release operating mode TM, which will be described later.

Because wrinkles tend to occur in the web 17, particularly after the cylinder disengagement M, it is preferable to reduce the occurrence of wrinkles using the tension-release operating mode TM.

In this case, because the transport speed of the web 17 changes greatly, the draw value is preferably changed in consideration of the transport speed.

While the printing operation is halted, the web 17 may be transported at the lowest speed, i.e., a low running speed, so as to perform cleaning of the blankets, removal of paper splicing portions to avoid overdrying of the web 17 in the drying unit 9, and so forth.

Here, a description is given in a case where a blanket cleaning process C is performed by operating the transport speed of the web 17 at this low running speed.

In this case, the tension of the web 17 is controlled in the tension-release operating mode TM shown in FIG. 4.

First, it is determined whether or not the tension-release operating mode TM is used (Step S1).

When the tension-release operating mode TM is used (YES), the currently set circumferential speed of the cooling drag 39, i.e., the circumferential speed during printing, specifically, a draw value during printing, is stored in the normal-draw-value storage unit 71 (Step S2).

Next, the decision unit 69 selects a draw value to be used from among the draw values in the first released-draw-value storage unit 73 to the fourth released-draw-value storage unit 79 based on the basis weight that is sent from the production control device and that is input to the input unit 65. In this case, a small draw value is selected because wrinkles may tend to occur in the web 17 as the basis weight thereof becomes small.

The selected draw value is sent from the output unit 67 to the cooling-unit shaftless motor 41, and the circumferential speed of the cooling drag 39 is changed (Step S3).

Because the blanket cylinders 35 have to be rotated for cleaning the blankets, the web offset press 1 is operated at low running speed (Step S4). With this slow operation, the web 17 is transported at low running speed.

At this time, the cooling drag 39 is operated based on a draw value smaller than the changed draw value during printing.

In this way, when the draw value (transport speed difference) of the cooling drag 39 relative to the in-feed drag 21 is made small, the tension applied to the web 17 passing through the printing section 7 becomes small. Accordingly, wrinkles can be prevented from occurring at the cooling drag 39 portion.

Even when using a thin web 17 having a small basis weight, for example, 54 g/m², if the draw value of the cooling drag 39 is, for example, 0%, the amount of paper drawn is substantially constant. Accordingly, wrinkles hardly occur in the cooling unit 11.

In addition, in the tension-release operating mode TM, because conventional draw control is simply performed by changing to a smaller setting of the draw value of the cooling drag 39, which transports the web 17 at a higher speed than the in-feed drag 21, stable operation can be realized, and a device, a sequence or a tension detector for control need not be added, thus preventing an increase in manufacturing costs.

On the other hand, when the tension-release operating mode TM is not used (NO) in Step S1, the process proceeds to Step S4, where the cooling drag 39 is operated at low running speed based on the draw value during printing.

In this way, it is possible to select between implementing the tension-release operating mode to enable changing to a smaller draw value only when using thin paper in which wrinkles tend to occur, or alternatively, not implementing the tension-release operating mode when using thick paper having high stiffness.

A blanket cleaning process C is performed to clean the blankets during the slow operation (see FIG. 3).

After completion of the blanket cleaning process C, next operation state, i.e., an operation instruction is determined (Step S5).

When the operation instruction is halt, the decision unit 69 sends the draw value during printing (during normal operation), stored in the normal-draw-value storage unit 71, to the cooling-unit shaftless motor 41 via the output unit 67, and the circumferential speed of the cooling drag 39 is changed (restored) (Step S6). Thereafter, the operation of the web offset press 1 is halted (Step S7).

When the operation instruction is accelerate, the decision unit 69 sends the draw value during printing (during normal operation), stored in the normal-draw-value storage unit 71, to the cooling-unit shaftless motor 41 via the output unit 67, and the circumferential speed of the cooling drag 39 is changed (restored) (Step S8). Thereafter, the operation of the web offset press 1 is accelerated (Step S9).

After completion of the blanket cleaning process C during the slow operation, the operation of the web offset press 1 is halted.

Thereafter, the web offset press 1 is re-activated for starting the printing operation, followed by a printing process.

In the printing process, a preset process D is performed for presetting the web offset press 1 according to printing conditions while running the web 17 at low running speed.

Next, a drying-unit heating process E is performed in which the web 17 is transported at substantially constant speed (heating speed) that is higher than the low running speed to reheat the drying unit 9.

A cleaning-liquid removing process H for removing a cleaning liquid from the blanket cylinders 35 is performed, in parallel with the drying-unit heating process E, by rotating the printing units 31 individually at high speed.

At this time, a reserve supply of ink is supplied to the ink-roller group concurrently with the cleaning-liquid removing process H.

Thereafter, the process proceeds to an acceleration process F for increasing the transport speed of the web 17.

While increasing the transport speed of the web 17 in the acceleration process F, the transport speed of the web 17 and the speed of each printing unit 31 are synchronized, and cylinder engagement N is performed where the blanket cylinders 35 in each of the printing units 31 are engaged with the web 17.

After the cylinder engagement N, the web 17 is transported at a substantially constant adjusting speed, and an adjusting process J is performed for color adjustment and for adjusting the register of the web 17.

After the adjusting process J, though not shown in the drawing, the speed is gradually increased from the adjusting speed to the production speed and then printing is performed.

In this printing process, the tension applied to the web 17 passing through the printing section 7 may be reduced using the tension-release operating mode TM.

In particular, because wrinkles tend to occur in the web 17 before the cylinder engagement N, it is preferable to reduce the occurrence of the wrinkles using the tension-release operating mode TM.

In this case, because the transport speed of the web 17 significantly varies, the draw value is preferably also changed in consideration of the transport speed.

Although the web offset press 1 and the operation method thereof are described as an embodiment of the present invention, the present invention is not limited thereto; various modifications can be made so long as they do not depart from the spirit of the present invention.

For example, the cooling drag 39 is used as a downstream drag in this embodiment; however, the web-path drag 43 may be used, or both the cooling drag 39 and the web-path drag 43 may be used.

1. A web offset press comprising:
a printing section that prints on a web that is transported;
an upstream drag that is provided upstream of the printing section and that adjusts a tension of the web and transports the web downstream;
a downstream drag that is provided downstream of the printing section and that transports the web at a transport speed higher than that of the upstream drag; and
a tension control unit that controls the tension of the web, wherein
the tension control unit has a tension-release operating mode in which a transport-speed difference between the downstream drag and the upstream drag is smaller than a transport-speed difference between the downstream drag and the upstream drag during printing.

2. A web offset press according to claim 1, wherein the transport-speed difference in the tension-release operating mode is set according to paper type.

3. An operation method for a web offset press including:
a printing section that prints on a web that is transported;
an upstream drag that is provided upstream of the printing section and that adjusts a tension of the web and transports the web downstream;
a downstream drag that is provided downstream of the printing section and that transports the web at a transport speed higher than that of the upstream drag; and
a tension control unit that controls the tension of the web,
wherein, when the transport speed of the web is lower than that during printing, the tension control unit performs a tension-release operation in which a transport speed difference between the downstream drag and the upstream drag is made smaller than a transport-speed difference between the downstream drag and the upstream drag during printing.

4. An operation method for a web offset press according to claim 3, wherein the transport-speed difference during the tension-release operation is set according to paper type.
